(19) United States
(12) Patent Application Publication
(10) Pub. No.: US 2017/0092183 A1
(43) Pub. Date: Mar. 30, 2017

(54) DISPLAY APPARATUS INCLUDING PIXEL CIRCUITS FOR CONTROLLING LIGHT MODULATORS

(71) Applicant: Pixtronix, Inc., San Diego, CA (US)

(72) Inventors: Ilias Pappas, Andover, MA (US); Yu-Hsuan Li, Hsin-Chu (TW); Sean Lord, Ottawa (CA)

(21) Appl. No.: 14/864,330

(22) Filed: Sep. 24, 2015

(51) Int. Cl. G09G 3/20

(52) U.S. Cl. CPC G09G 3/2092

(57) ABSTRACT

This disclosure provides systems, methods and apparatus for controlling the states of a light modulator used in displays. A display apparatus includes pixels circuit for controlling the state of operation of dual actuator light modulators. The pixel circuit can be implemented using three transistors and a capacitor. In particular, the pixel circuit can include a charge-discharge transistor, a data transistor, and a feedback transistor. The charge-discharge transistor is used to both selectively charge and selectively discharge an output node of the pixel circuit coupled to the light modulator. The data transistor enables loading a data capacitor with data voltage representative of image data. The feedback transistor provides positive feedback to allow the output node to be charged to the actuation voltage via the charge-discharge transistor.

### TECHNICAL FIELD

This disclosure relates to the field of imaging displays, and in particular to pixel circuits for display elements.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using one or more of deposition, etching, lithography, and other micromachining processes that etch away parts of one or more of substrates and deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus including a light modulator capable of selectively allowing passage of light and a pixel circuit having an output node coupled to the light modulator. The pixel circuit includes a charge-discharge transistor configured to selectively charge and selectively discharge the output node coupled to one of its source/drain terminals through application and removal of an actuation voltage provided by an actuation voltage source at the other one of its source/drain terminals. The pixel circuit also includes a data storage capacitor having a first terminal coupled to the gate terminal of the charge-discharge transistor and a second terminal coupled to the output node configured to store a data voltage representative of image data. The pixel circuit further includes a feedback transistor configured to selectively provide charge to the gate terminal of the charge-discharge transistor and to the data storage capacitor coupled to its drain terminal from a feedback voltage provided at its source terminal.

In some implementations, the gate terminal of the feedback transistor is coupled to the output node, and the feedback transistor is configured to selectively provide charge to the data store capacitor when the output node is charged by the charge-discharge transistor. In some implementations, the output node is coupled to a shutter terminal of the light modulator. In some implementations, the light modulator is provided with an actuation voltage on one of its two actuators such that the state of the light modulator is maintained when the output node is discharged by the charge-discharge transistor. In some implementations, the other of the two actuators of the light modulator is maintained at a constant voltage. In some implementations, the output node is coupled to an actuator of the light modulator.

In some implementations, the display apparatus further includes an input transistor, one of the source/drain terminals of which is coupled to the first terminal of the storage capacitor, the other of the source/drain terminal of which is coupled to a data interconnect, and a gate terminal of which is coupled to a row enabling interconnect. In some implementations, each of the charge-discharge transistor and the feedback transistor is an n-type transistor.

In some implementations, the display apparatus further includes a display including the array of display elements, and the control matrix. In some implementations, the display apparatus also includes a processor that is capable of communicating with the display, the processor being capable of processing image data, and a memory device that is capable of communicating with the processor. In some implementations, a driver circuit capable of sending at least one signal to the display, and a controller capable of sending at least a portion of the image data to the driver circuit. In some implementations, the display apparatus further includes an image source module capable of sending the image data to the processor, where the image source module includes at least one of a receiver, transceiver, and transmitter. In some implementations, the display apparatus further includes an input device capable of receiving input data and to communicate the input data to the processor.

Another innovative aspect of the subject matter described in this disclosure can be implemented in a method for actuating a dual actuator light modulator using a pixel circuit having an output node coupled to the light modulator. The method includes discharging the output node via a charge-discharge transistor, one source/drain terminal of which is coupled to the output node, by reducing an actuation voltage provided at the other source/drain terminal of the charge-discharge transistor. The method further includes altering a voltage provided to at least one actuator of the dual actuator light modulator such that a state of the dual actuator light modulator is maintained when the output node is discharged. The method also includes loading a data voltage on a data capacitor, one terminal of which is coupled to the gate terminal of the charge-discharge transistor, and the other terminal of which is coupled to the output node. The method additionally includes selectively charging the output node, based in part on the data voltage stored in the data capacitor, via the charge-discharge transistor by increasing the actuation voltage. The method also includes charging the terminal of the data capacitor coupled to the gate terminal of the charge-discharge transistor from a feedback voltage source via a feedback transistor, a gate terminal of which is coupled to the output node.

In some implementations, the method further includes restoring the voltage provided to the at least one actuator of the dual actuator light modulator after increasing the actuation voltage. In some implementations, altering a voltage provided to at least one actuator of the dual actuator light modulator such that a state of the dual actuator light modulator is maintained when the output node is discharged includes altering the voltage provided to the at least one actuator substantially simultaneously with reducing the actuation voltage. In some implementations, charging the terminal of the data capacitor coupled to the gate terminal of the charge-discharge transistor from a feedback voltage source via a feedback transistor, a gate terminal of which is coupled to the output node includes charging the terminal of the data capacitor such that the data voltage stored in the data capacitor is maintained.

Another innovative aspect of the subject matter described in this disclosure can be implemented in a display apparatus including light modulating means for selectively allowing passage of light. The display apparatus further includes charge-discharge means for selectively charging and selectively discharging an output node coupled to the light modulating means through an actuation voltage source. The display apparatus also includes data storage means coupled to the charge-discharge means for storing a data voltage representative of image data. The display apparatus additionally includes feedback means for selectively providing charge to the data storage means from a feedback voltage source.

In some implementations, the feedback means provide charge to the data storage means from a feedback voltage source when the output node is charged by the charge-discharge means. In some implementations, the light modulating means include a shutter and at least two actuators, where the output node is coupled to the shutter. In some implementations, the light modulating means is provided with an actuation voltage on one of its at least two actuators such that the state of the light modulating means is maintained when the output node is discharged by the charge-discharge means.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a schematic of an example pixel circuit for controlling a light modulator.

FIG. 4 shows an example timing diagram for the pixel circuit shown in FIG. 3.

FIGS. 5A-5I show the state of the pixel circuit shown in FIG. 3 at various times in the timing diagram shown in FIG. 4.

FIG. 6 shows a schematic diagram of an example control matrix.

FIG. 7A shows an example flow diagram of a process for operating a dual actuator light modulator using a pixel circuit, such as the pixel circuit shown in FIG. 3.

FIG. 7B shows another example flow diagram of a process for operating a dual actuator light modulator using a pixel circuit, such as the pixel circuit shown in FIG. 3

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls, cockpit displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus includes pixel circuits for controlling the state of operation of dual actuator light modulators. The pixel circuit can be implemented using three transistors and a capacitor. In particular, the pixel circuit can include a charge-discharge transistor, a data transistor, and a feedback transistor in addition to a data capacitor. The charge-discharge transistor is used to both selectively charge and selectively discharge an output node of the pixel circuit coupled to the light modulator. The data transistor enables loading of the data capacitor with a data voltage representative of image data. The feedback transistor provides positive feedback to allow the output node to be charged to the actuation voltage via the charge-discharge transistor.

The operation of addressing and actuating the light modulator using the pixel circuit can proceed in three phases: a discharge phase, a data-load phase, and an actuation phase. In the discharge phase, the output node is discharged via the charge-discharge transistor. In addition, voltage on an electrode of one of the actuators of the light modulators is altered such that the state of the light modulator is maintained despite the discharging of the output node. In the data-load phase, the data capacitor is loaded with the data voltage. In the actuation phase, the output node is selectively charged via the charge-discharge transistor based, in part, on the data voltage stored on the data capacitor. Further, with an increase in the voltage on the output node, the feedback transistor is used to charge and increase the voltage of the node connected to the data capacitor and to the gate terminal of the charge-discharge transistor so that the output node to charge up to the actuation voltage.

Particular implementations of the subject matter described in this disclosure can be implemented to realize one or more of the following potential advantages. By providing a pixel circuit with only three transistors and a capacitor, the size of the pixel circuit, and in turn the relative size of the control matrix is greatly reduced. This reduction size of the control matrix can be utilized, for example, to increase the pixel density of the display or to increase the aperture ratio of the pixels. By using a feedback transistor, the voltage at the output node can be increased all the way up to the actuation voltage provided by an actuation voltage source needed to actuate the light modulator, thereby resulting in a rail-to-rail voltage swing at the output node. This allows a reduction in the magnitude of the voltage output by the actuation voltage source, thereby reducing power consumption.

By altering the voltage on one of the actuators of the light modulators during a discharge phase of operation of the pixel circuit, the state of the light modulator can be maintained even when data for the next image frame is being loaded into the pixel circuit. This allows additional time for which light sources or backlight can be illuminated, thereby providing the opportunity to reduce intensity and reduce power or introduce additional subframes to improve image quality, or both reduce intensity and introduce additional subframes. In some implementations, by providing charging and discharging of various nodes within the pixel circuit through application and removal of an actuation voltage from the same voltage source, the display recycles charge between the voltage source and the pixel circuit. Recycling charge, in turn, reduces the power consumed by the pixel circuit.

In some implementations, the pixel circuit exhibits greater tolerance or immunity to variations in the threshold voltages of the transistors used in the pixel circuit. The rail-to-rail operation of the pixel circuit can be based on positive feedback, which is triggered by the data voltage stored in the data capacitor. The positive feedback is generally not affected by changes in the threshold voltages of the transistors within the pixel circuit. By providing a pixel circuit that exhibits high tolerance to threshold voltage variations, the need for threshold voltage compensation circuits is mitigated, thereby reducing the power and chip area associated with such compensation circuits.

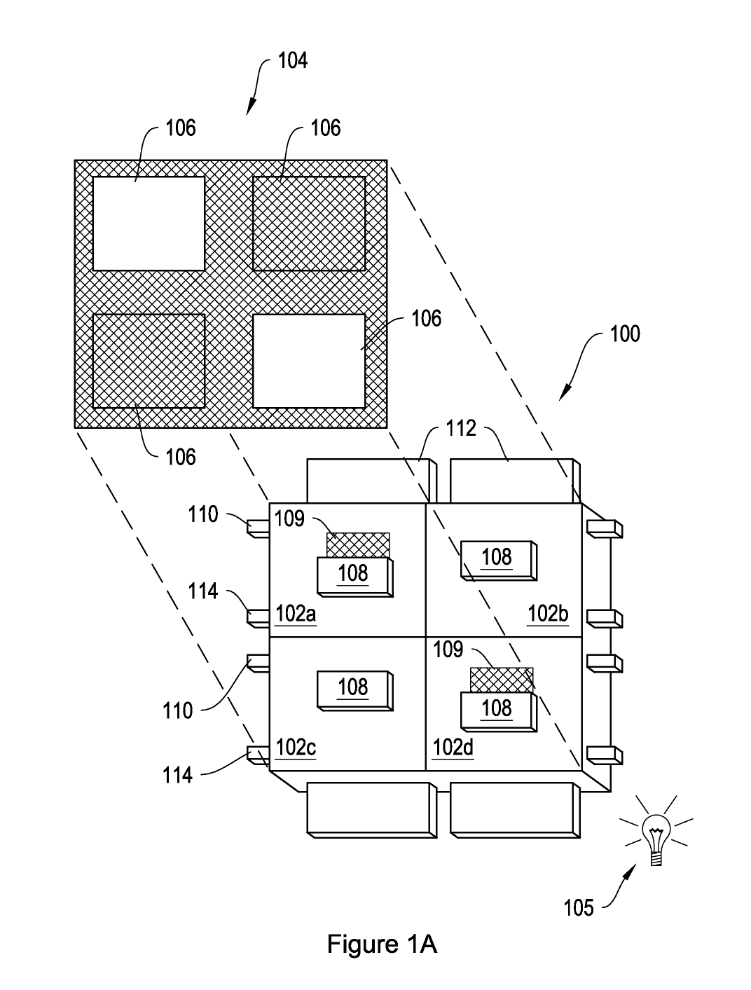

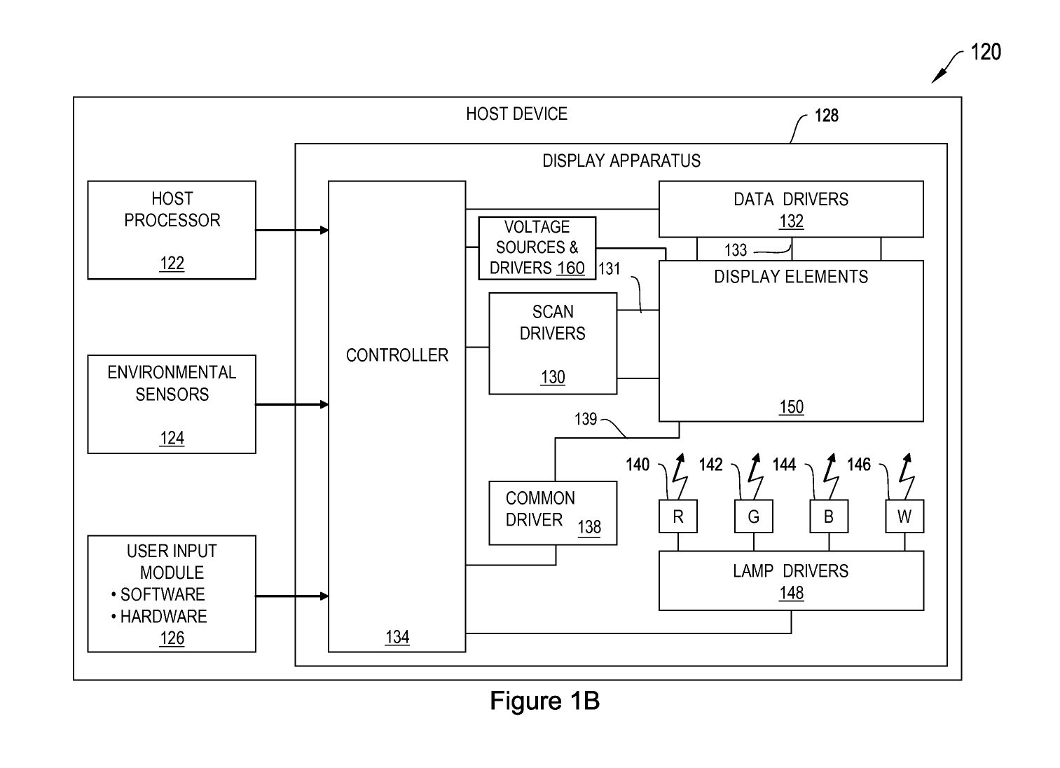

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness, enhancing contrast, or enhancing both brightness and contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a light guide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133. In some implementations, the display apparatus 128 also can include additional voltage sources and drivers 160 to provide additional voltages to the display elements 150. For example, in some implementations, the voltage sources and drivers 160 can include an actuation voltage source, a feedback voltage source, a shutter-open global voltage source, and a shutter-close global voltage source. The digital controller 134 can control the output voltage and timing of each of the voltage sources and drivers 160.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving, initiating, or both driving and initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include one or more of data from environmental sensors 124, such as ambient light or temperature; information about the host device 120, including, for example, an operating mode of the host or the amount of power remaining in the host device's power source; information about the content of the image data; information about the type of image data; and instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

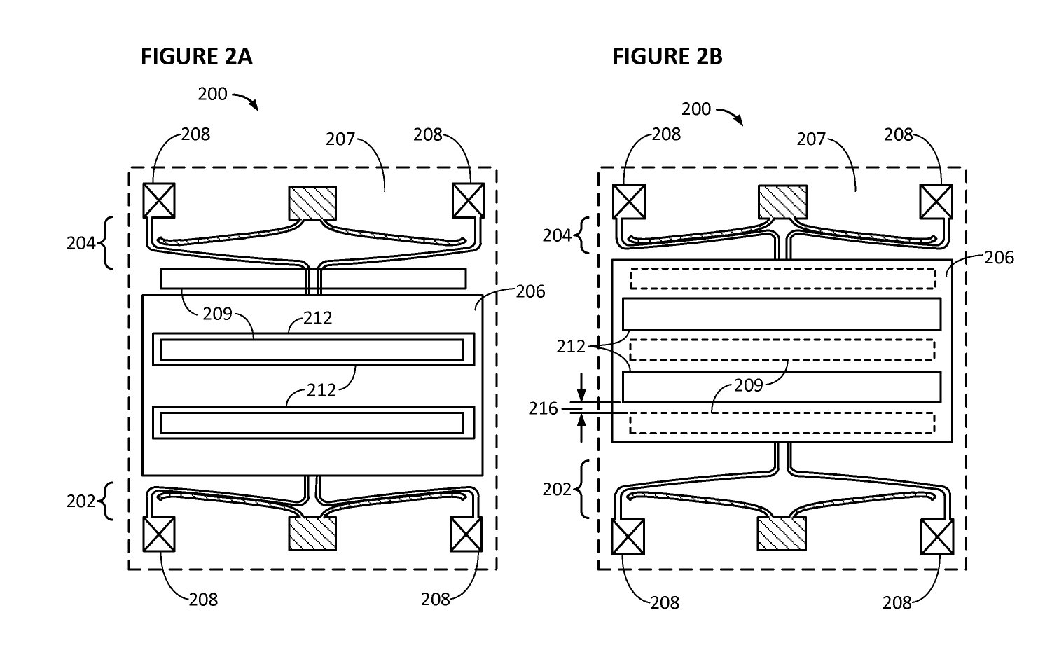

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Generally, electrical bi-stability in electrostatic actuators, such as actuators 202 and 204, arises from the fact that the electrostatic force across an actuator is a strong function of position as well as voltage. The beams of the actuators in the light modulator 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, such as 200 the equilibrium position of the light modulator will be determined by the combined effect of the voltage differences across each of the actuators. In other words, the electrical potentials of the three terminals, namely, the shutter open drive beam, the shutter close drive beam, and the load beams, as well as modulator position, are considered to determine the equilibrium forces on the modulator.

For an electrically bi-stable system, a set of logic rules can describe the stable states and can be used to develop reliable addressing or digital control schemes for a given light modulator. Referring to the shutter-based light modulator 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems an exceptional degree of bi-stability or hysteresis can be provided, with Vₘ existing over a range of about 2% and about 98% of Vₐₜ. In these systems, however, care must be taken to ensure that an electrode voltage condition of |V_{c}-Vₛ| or |Vₒ−Vₛ| being less than Vₘ can be reliably obtained within the addressing and actuation time available.

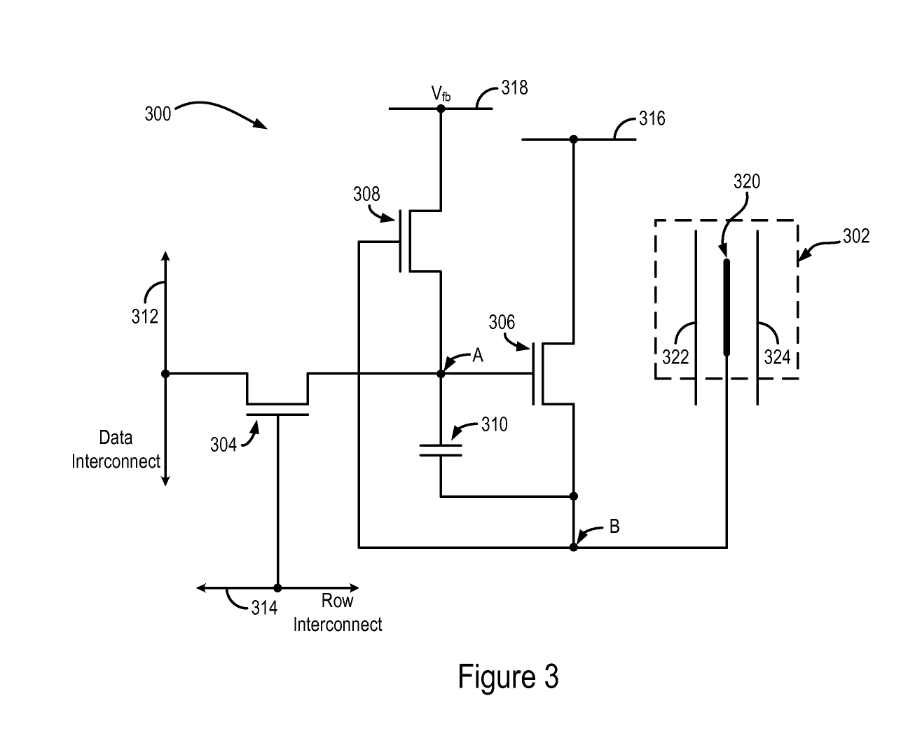

FIG. 3 shows a schematic of an example pixel circuit 300 for controlling a light modulator 302. In particular, the pixel circuit 300 can be used for controlling dual actuator light modulators, such as the light modulator 200 shown in FIGS. 2A and 2B. In some implementations, the pixel circuit 300 can be part of a control matrix used for controlling an array of light modulators 302, such as, for example, the array of display elements 150 shown in FIG. 1B.

The pixel circuit 300 includes a data transistor 304, a charge-discharge transistor 306, a feedback transistor 308, and a data capacitor 310. In some implementations, various components of the pixel circuit 300 can be implemented using thin film transistors (TFTs). In some implementations, the TFTs can be manufactured using materials such as amorphous-silicon (a-Si), indium-gallium-zinc-oxide (IGZO), or polycrystalline-silicon (poly-Si). In some other implementations, various components of the pixel circuit 300 can be implemented using MOSFETs. As will be readily understood by a person having ordinary skill in the art, TFTs are three terminal transistors having a gate terminal, source terminal, and a drain terminal. The gate terminal can act as a control terminal such that a voltage applied to the gate terminal in relation to the source terminal can switch the TFT ON or OFF. In the ON state, the TFT allows electrical current flow from the source terminal to the drain terminal. In the OFF state, the TFT substantially blocks any current flow from the source to the drain. The implementation of the pixel circuit 300, however, is not limited to TFTs or MOSFETS, and other transistors such as bipolar junction transistors (BJTs) also may be utilized.

A first source/drain terminal of the data transistor 304 can be coupled to a data interconnect 312, which can provide a data voltage representative of image data, while the second source/drain terminal of the data transistor 304 can be coupled to the gate terminal of the charge-discharge transistor 306, to a source terminal of the feedback transistor 308, and to a first terminal of the data capacitor 310. A circuit node labeled “A” denotes the circuit node to which the second source/drain terminal of the data transistor 304, the source of the feedback transistor 308, the gate terminal of the charge-discharge transistor 306 and the first terminal of the data capacitor 310 are connected. The gate terminal of the data transistor 304 can be coupled to a row interconnect 314, which can provide a row enable signal.

A first source/drain terminal of the charge-discharge transistor 306 can be coupled to an actuation voltage interconnect 316, which can be connected to an actuation voltage source for providing an actuation voltage (such as 0 V to V_{act}). The second source/drain terminal of the charge-discharge transistor 306 can be coupled to the second terminal of the data capacitor 310, the gate terminal of the feedback transistor 308 and a shutter 320 of the light modulator 302. A circuit node labeled “B” denotes the circuit node to which the second source/drain terminal of the charge-discharge transistor 306, the second terminal of the data capacitor 310, the gate terminal of the feedback transistor 308 and the shutter 320 are connected. The source terminal of the feedback transistor 308 is coupled to Node A, while the drain terminal of the feedback transistor 308 can be coupled to a feedback voltage interconnect 318, which can be connected to a feedback voltage source for providing a feedback voltage V_{fb}. In some implementations, the actuation voltage interconnect 316 can provide a variable or switched actuation voltage that can switched between 0 V and V_{act}. In some implementations, the feedback voltage interconnect 318 can provide a constant feedback voltage V_{fb}.

In some implementations, the actuation voltage interconnect 316 can be a global interconnect that connects to the charge-discharge transistor 306 in each of the pixel circuits 300 in a control matrix. In some implementations, the feedback voltage interconnect 318 also can be a global interconnect that connects to a feedback transistor 308 in each of the pixel circuits 300 in the control matrix. In some other implementations, the pixel circuits 300 within the control matrix can be grouped into various portions, where each portion includes pixel circuits 300 belonging to at least two rows and two columns of the control matrix. In some such implementations, the actuation voltage interconnect 316 or the feedback voltage interconnect 318, or both the actuation voltage interconnect 316 and the feedback voltage interconnect 318 can be common to particular pixel circuits 300 within a particular portion. For example, a display may be divided into halves, quadrants, eights, or other sized portions.

As mentioned above, the light modulator 302 can be a dual actuator light modulator, and can include, in addition to the shutter 320, a shutter-open actuator 322 and a shutter-close actuator 324. Each of the shutter-open actuator 322 and the shutter-close actuator 324 can include two electrodes: a drive beam electrode and a load beam electrode. For example, the shutter-open actuator 322 and the shutter-close actuator 324 can be similar to the shutter open actuator 204 and shutter close actuator 204 shown in FIGS. 2A and 2B. As such, the load beam electrode of each of the shutter-open actuator 322 and the shutter-close actuator 324 can be attached to the shutter 320, and can receive voltage from the pixel circuit 300. The drive beam electrodes of the shutter-open actuator 322 and the shutter-close actuator 324 can each be connected to an interconnect, which provides the appropriate voltage to the respective actuator drive beam. As referred to hereinafter, unless explicitly stated otherwise, reference to voltages applied or provided to the shutter-open actuator 322 and the shutter-close actuator 324 specifically refers to the voltages applied or provided to the drive beam electrodes of the respective actuators. In some implementations, one of the shutter-open actuator 322 and the shutter-close actuator 324 can be maintained at a constant voltage, while the other of the shutter-open actuator 322 and the shutter-close actuator 324 can be provided with a variable or switched voltage. Additional details of the voltages applied to the actuators of the light modulator 302 are discussed further below in conjunction with the discussion of the operation of the pixel circuit 300.

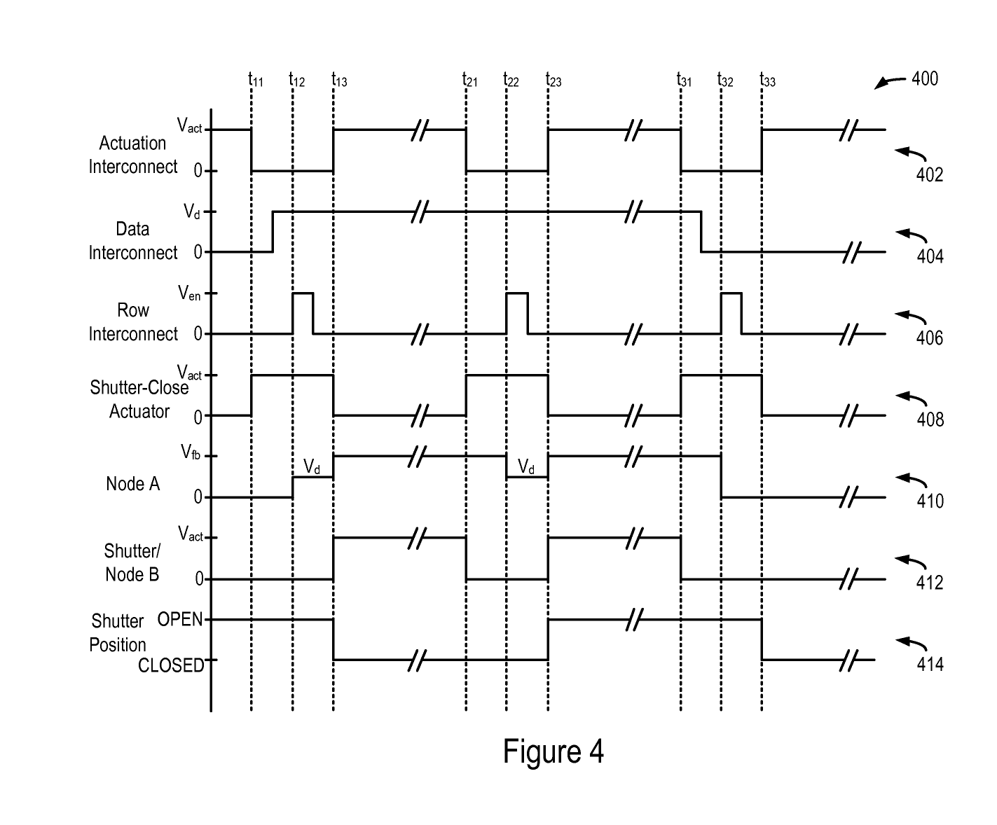

FIG. 4 shows an example timing diagram 400 for the pixel circuit 300 shown in FIG. 3. In particular, the timing diagram 400 shows voltage levels at various nodes of the pixel circuit 300. The timing diagram 400 includes an actuation voltage waveform 402 depicting the voltage on the actuation voltage interconnect 316, a data voltage waveform 404 depicting the voltage on the data interconnect 312, an enable voltage waveform 406 depicting the row enable voltage on the row interconnect 314, a shutter-close actuator voltage waveform 408 depicting voltage on the shutter-close actuator 324, a Node A voltage waveform 410 depicting the voltage at Node A, a Node B voltage waveform 412 depicting the voltage at Node B (and the shutter 320), and a shutter position waveform 414 depicting the position of the shutter 320 (OPEN or CLOSED). It should be noted that the relative voltages and timings shown in the timing diagram 400 are not drawn to scale. Moreover, the ranges of voltages associated with various voltage waveforms represent example ranges, and different implementations may employ different voltage ranges.

The timing diagram 400 shows the operation of the pixel circuit 300 for controlling the state of the light modulator 302 based on data over three image frames. For example, the time period t₁₁ to t₁₃, time period t₂₁ to t₂₃, and time period t₃₁ to t₃₃ represent the operation of the pixel circuit 300 for controlling the state of the light modulator 302 based on data over a first, second, and a third image frame, respectively. The above specified time periods can alternatively represent the operation of the pixel circuit 300 over three image sub-frames of a time-division gray-scale image formation process, which can be combined (by themselves or with additional image sub-frames) to display an image frame. During each image frame, the pixel circuit 300 operates in three phases: a discharge phase, a data-load phase, and an actuation phase. As discussed further below, during the discharge phase (from t₁₁ to t₁₂, from t₂₁ to t₂₂, and from t₃₁ to t₃₂) the shutter 320/Node B is discharged via the charge-discharge transistor 306, during the data-load phase (from t₁₂ to t₁₃, from t₂₂ to t₂₃, and from t₃₂ to t₃₃) the data voltage provided by the data interconnect 312 is loaded into the data capacitor 310, and during the actuation phase (from t₁₃ onwards, from t₂₃ onwards, and from t₃₃ onwards), the light modulator 302 is actuated based on the data voltage loaded into the data capacitor 310.

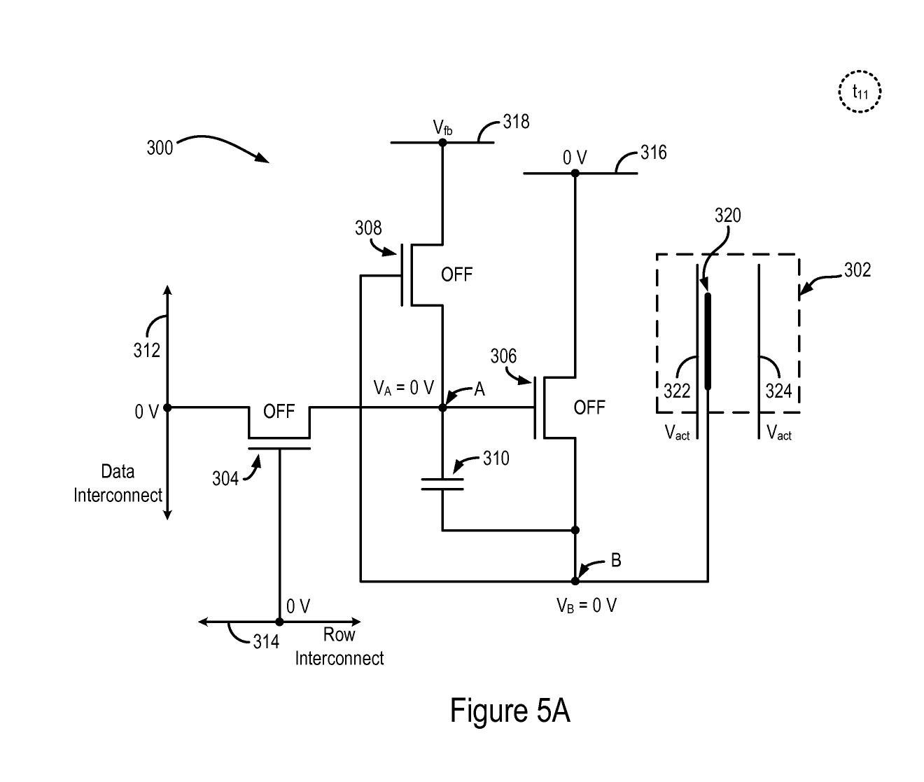

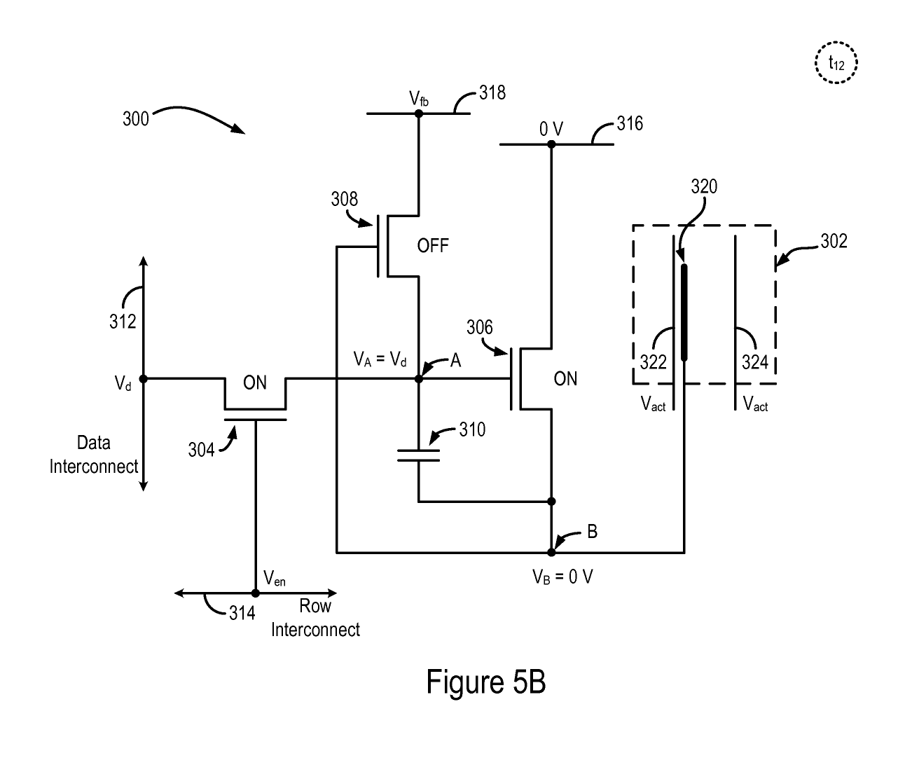

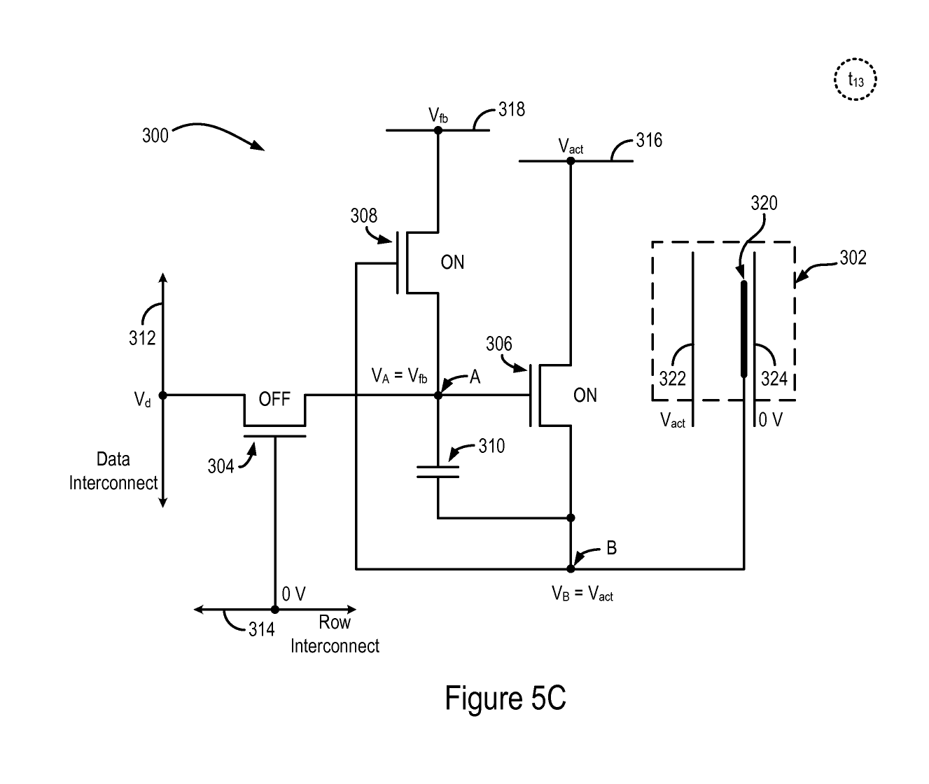

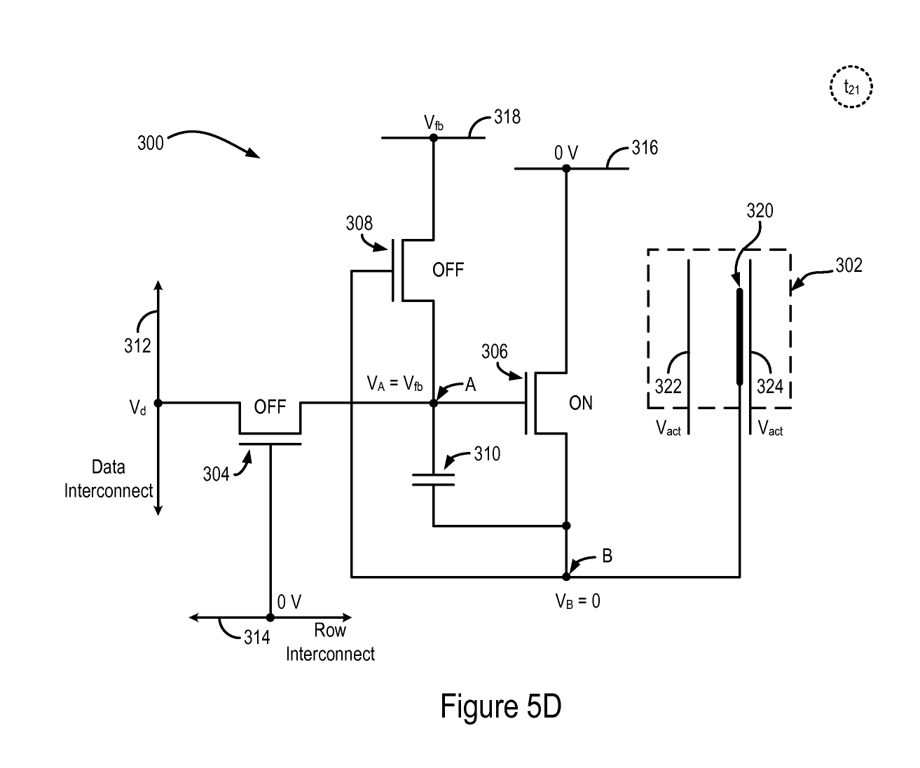

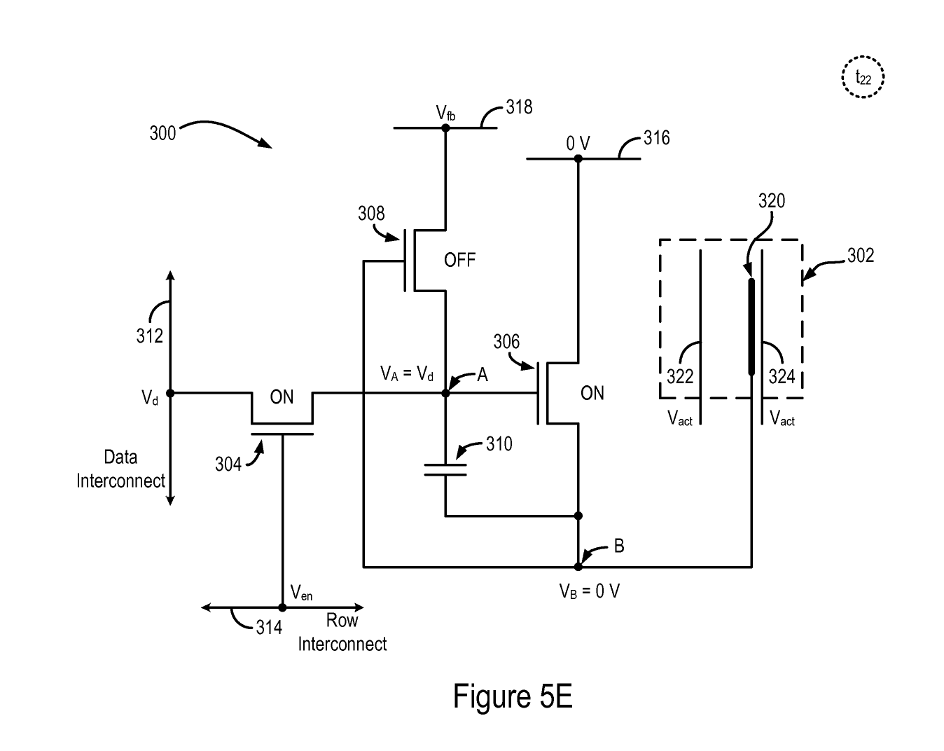

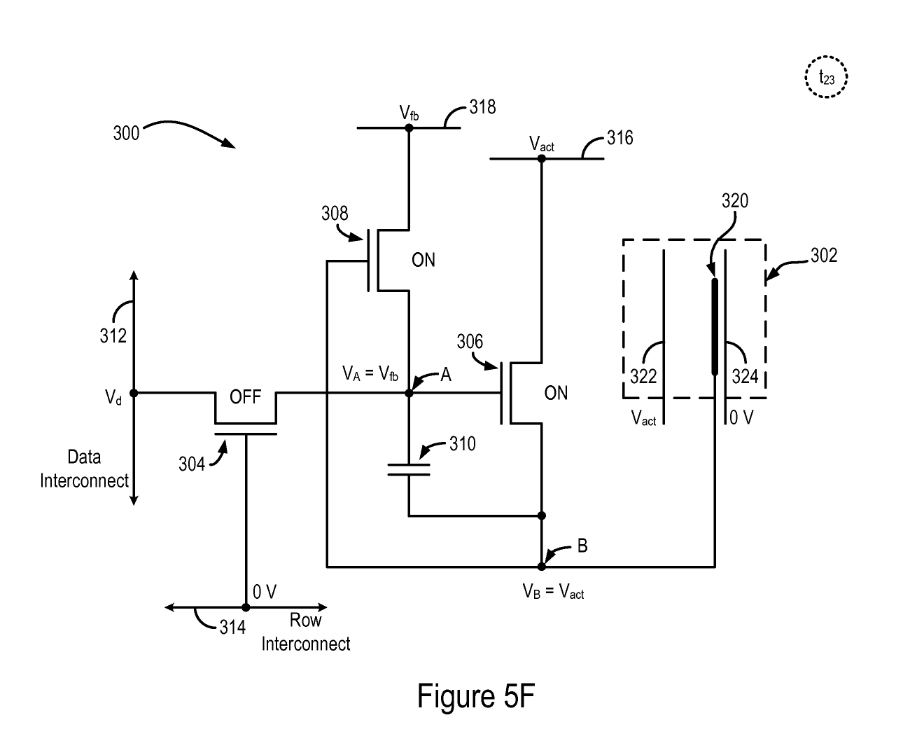

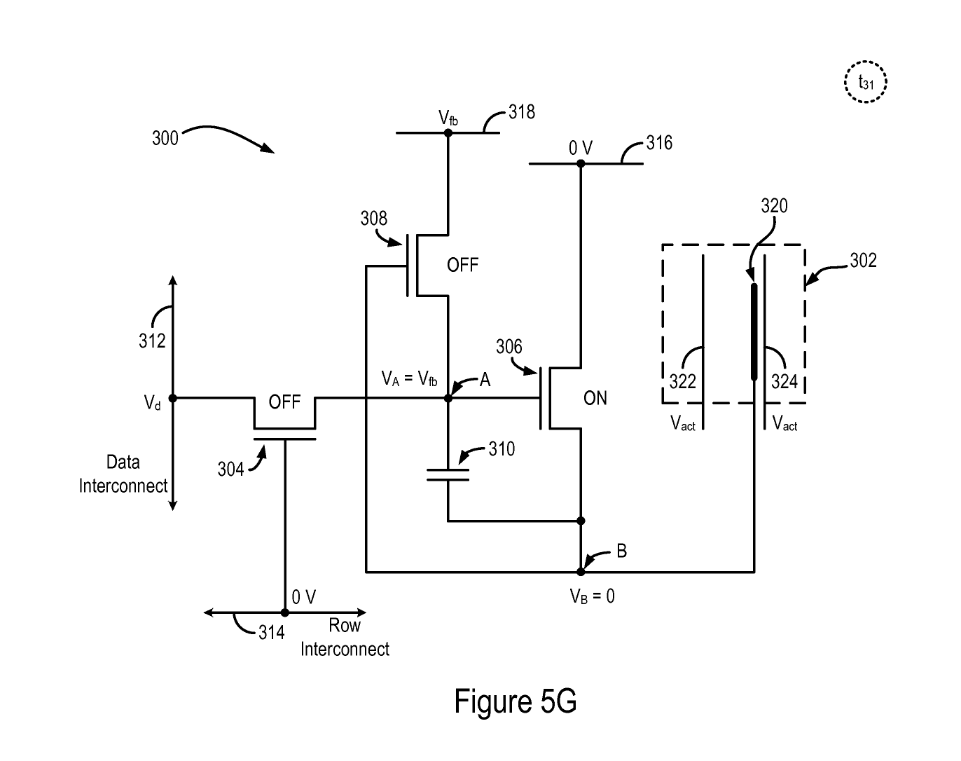

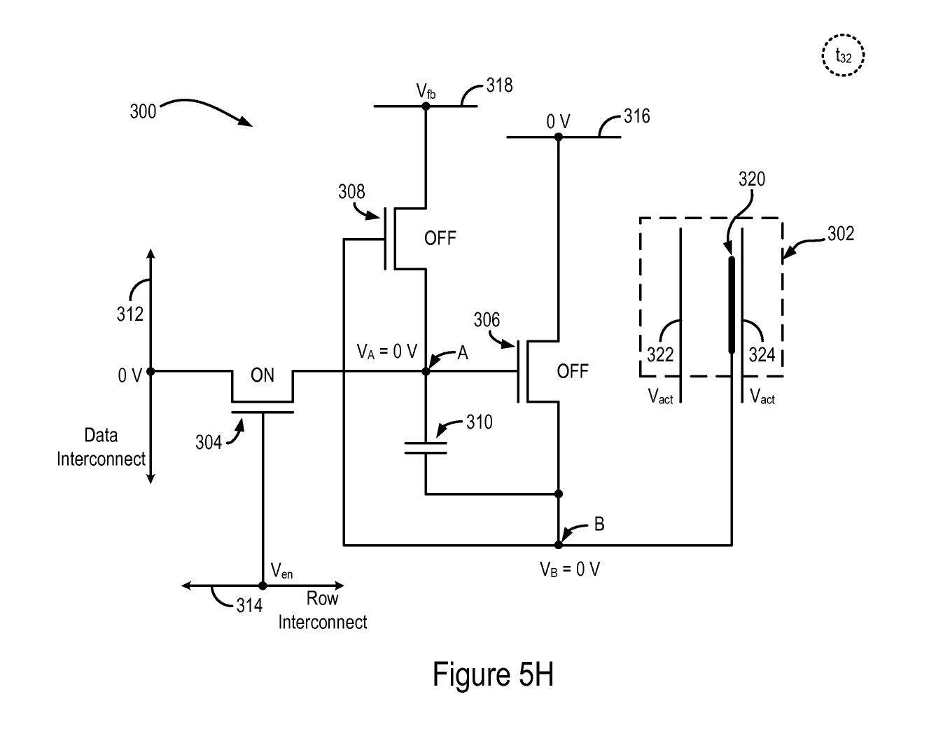

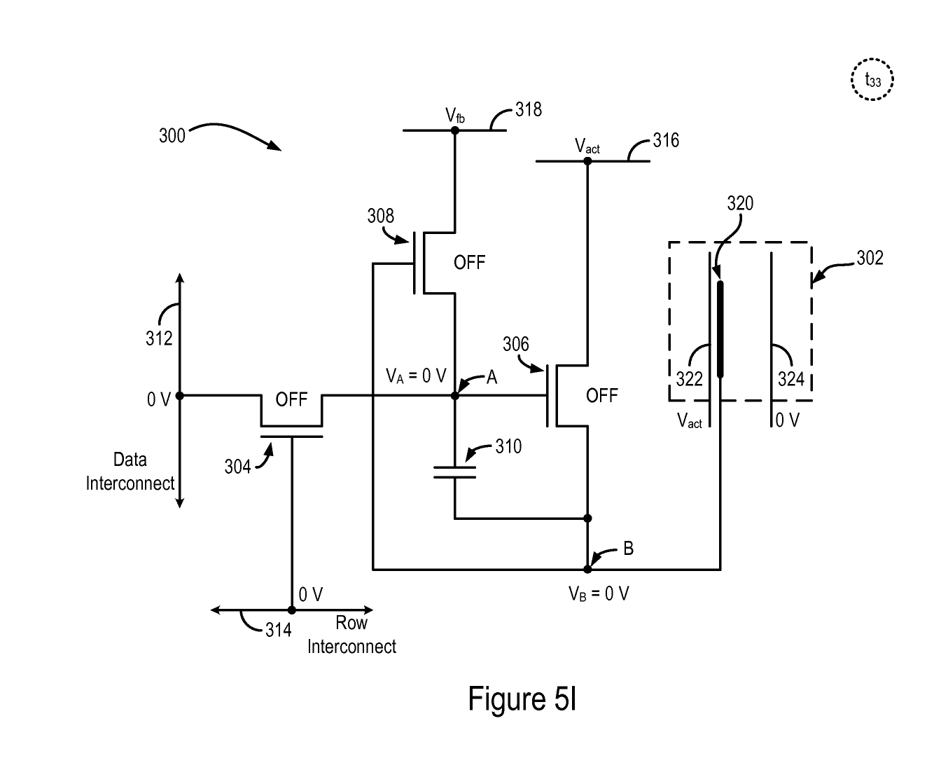

FIGS. 5A-5I show the state of the pixel circuit 300 shown in FIG. 3 at various times in the timing diagram 400 shown in FIG. 4. In particular, FIGS. 5A, 5B, and 5C show the state of the pixel circuit 300 and the light modulator 302 at about the times t₁₁, t₁₂, and t₁₃, respectively, shown in FIG. 4; FIGS. 5D, 5E, and 5F, show the state of the pixel circuit 300 and the light modulator 302 at about the times t₂₁, t₂₂, and t₂₃, respectively; and FIGS. 5G, 5H, and 5I show the state of the pixel circuit 300 and the light modulator 302 at about the times t₃₁, t₃₂, and t₃₃, respectively. The operation of the pixel circuit 300 and the light modulator 302 is discussed below with reference to FIGS. 4 and 5A-5I.

Before the start of the discharge phase at time t₁₁, as shown in the actuation voltage waveform 402 in FIG. 4, the actuation voltage interconnect 316 is maintained at V_{act}. In some implementations, the value of V_{act} can be selected based on the actuation voltage needed to actuate the light modulator 302. For example, V_{act} can be equal to about 15-35 V, or 20-30 V, or about 25 V. In some implementations, V_{act} can be selected to be at least equal to V_{data}. In some implementations, V_{act} can be selected to be no more than the voltage needed to cause the shutter 320 to actuate. The data voltage waveform 404 shows that the data interconnect 312 is maintained at about 0 V, which represents the data voltage loaded into the data capacitor 310 during the previous image frame. Further, the row enable signal on the row interconnect 314, as shown in the enable voltage waveform 406, is maintained at about 0 V. The shutter-close actuator 324 is maintained at about 0 V, as shown in the shutter-close actuator voltage waveform 408. While not shown in the timing diagram 400, the shutter-open actuator 322 can be maintained throughout the operation of the pixel circuit 300 at a voltage that is substantially equal to V_{act}. As the data voltage before time t₁₁ is equal to 0 V, both the Node A voltage V_{A} and the shutter/Node B voltage V_{B} are about 0 V. In some implementations, Node A and Node B may not be fully discharged to 0 V. As the voltage on the shutter 320 is about 0 V, and the voltages on the shutter-open actuator 322 and the shutter-close actuator 324 are at V_{act} and 0 V, respectively, the shutter 320 is pulled towards the shutter-open actuator 322. Thus, the state of the light modulator 302, as shown in the shutter position waveform 414, is OPEN.

At the start of the discharge phase at time t₁₁, the voltage on the actuation voltage interconnect 316 is lowered to about 0 V. In addition, the voltage on the shutter-close actuator 324 is raised to the actuation voltage V_{act}. As shown in FIG. 5A, the voltage V_{A} on Node A as well as the voltage V_{B} on the shutter/Node B, is at about 0 V. As a result, both the charge-discharge transistor 306 and the feedback transistor 308 are in the OFF state. Thus the lowering of the voltage on the actuation voltage interconnect 316 coupled to a source/drain terminal of the charge-discharge transistor 306 does not change the voltage on the shutter/Node B. As a result, the shutter 320, which was previously in the OPEN position, continues to remain in the OPEN position. The shutter 320 remains in the OPEN position despite the voltage on the shutter-close actuator 324 being raised to the actuation voltage. This is because, as discussed above in relation to rule 2, when the voltage difference between the shutter and a drive beam of a first actuator with which the shutter is in contact with is above a maintenance voltage, then a change in the voltage on the drive beam of a second actuator opposing the first actuator does not affect the position of the shutter. Thus, as the voltage difference (V_{act}) between the shutter-open actuator 322 and the shutter 320 is above a maintenance voltage Vₘ, the shutter 320 remains in contact with the drive beam of the shutter-open actuator 322.

The data-load phase begins at time t₁₂. As shown in FIG. 4, the row enable voltage on the row interconnect 314 transitions from 0 V to Vₑₙ. The voltage Vₑₙ can be selected such that the application of the voltage Vₑₙ to the data transistor 304 is sufficient to cause the data transistor 304 to switch ON. For example, the voltage Vₑₙ can be selected to be greater than the highest data voltage that can appear on the data interconnect 312 by about the threshold voltage of the data transistor 304 (for example, Vₑₙ can be selected to be between about 15 V and about 25 V). Before the change in the voltage on the row interconnect 314, a data voltage is provided on the data interconnect 312. For example, as shown in the data voltage waveform 404, the voltage on the data interconnect 312 changes from 0 V to V_{d}. In some implementations, the data voltage V_{d} can be equal to a voltage that is sufficient to cause the charge-discharge transistor 306 to switch ON (for example, V_{d} can be selected to be between about 3 V and about 6 V). The actuation voltage interconnect 316 and the shutter-close actuator 324 are maintained at 0 V and V_{act}, respectively, as shown in the actuation voltage waveform 402 and the shutter-close actuator voltage waveform 408.

As shown in FIG. 5B, the row enable voltage on the row interconnect 314 being raised to Vₑₙ causes the data transistor 304 to switch ON. As a result, the data voltage V_{d} on the data interconnect 312 appears on Node A (also shown in the Node A voltage waveform 410 in FIG. 4). As Node A is connected to the gate terminal of the charge-discharge transistor 306, the charge-discharge transistor 306 switches ON, causing the voltage at the shutter/Node B to be maintained at about 0 V. As the shutter 320 is at 0 V, the shutter 320 continues to remain in the OPEN position, as shown in the shutter position waveform 414 in FIG. 4. As the data capacitor 310 is connected between Node A and Node B, the data capacitor 310 is charged to the voltage V_{d}. Thereafter, the row enable voltage on the row interconnect 314 is lowered to 0 V, which causes the data transistor 304 to switch OFF. This results in the data voltage of V_{d} being maintained across the data capacitor 310.

The actuation phase begins at time t₁₃. As shown in the actuation voltage waveform 402 in FIG. 4, at time t₁₃ the voltage on the actuation voltage interconnect 316 is raised to V_{act}. Referring to FIG. 5C, the increase in the voltage on the actuation voltage interconnect 316 to V_{act} causes current to flow from the actuation voltage interconnect 316, via the charge-discharge transistor 306 (which is switched ON), to Node B. As a result, the voltage at Node B begins to increase. The data capacitor 310, which is connected between Node A and Node B, and is previously charged to V_{d}, acts as a floating capacitor. As a result, an increase in the voltage at Node B causes a similar increase in the voltage at Node A. At a certain point, the increase in the voltage at Node B, which is connected to the gate terminal of the feedback transistor 308 can cause the feedback transistor 308 to switch ON. For example, the voltage at Node B may increase faster than the increase in voltage on the Node A due to the data capacitor 310 connected between Node A and Node B. This difference in the rate of increase of the voltages on Node B and on Node A may cause the difference between the voltage on Node B and the voltage on Node A to exceed the threshold voltage of the feedback transistor 308, thereby switching ON the feedback transistor 308. As a result, the Node A receives charge from the feedback voltage interconnect 318, further increasing the voltage on Node A. This increase in the voltage at Node A, in turn, causes additional charge to flow into Node B and further increase in voltage on Node B. This positive feedback allows the voltage on Node B to go as high as the V_{act}.

In some implementations, the feedback voltage V_{fb} is selected to be greater than V_{act}. In some such implementations, a higher feedback voltage V_{fb} can eventually allow Node A to be charged to a voltage that is greater than V_{act}. As a result, Node B can be charged to a voltage that is substantially equal to V_{act} without switching OFF the charge-discharge transistor 306. Thus, the pixel circuit 300 can provide a rail-to-rail operation, that is, allow the voltage on the shutter 320 to swing between 0 V and V_{act}.

Also at time t₁₃, the voltage on the shutter-close actuator 324 is changed from V_{act} to 0 V, as show in the shutter-close actuator voltage waveform 408 in FIG. 4. Referring to FIG. 5C, the transition of the voltage on the shutter-close actuator 324 from V_{act} to 0 V can result in the shutter 320, which is at V_{act}, to be pulled towards the shutter-close actuator 324. Thus, the state of the light modulator 302 changes to CLOSED, as shown in the shutter position waveform 414 in FIG. 4. The shutter-close actuator 324 can be maintained at 0 V until the beginning of the discharge phase associated with the following image frame.

In some implementations, the backlight or light sources that were ON for displaying the previous image frame, can be turned OFF prior to entering the actuation phase for the first image frame. In some implementations, after a duration after time t₁₃ that is sufficient to allow the shutter 320 to come to a stop, the backlight or the light sources can be turned ON to display the first image frame. In some implementations, the backlight or light sources may be turned OFF as the following image frame enters its respective actuation phase.

As mentioned above, the discharge phase for the second image frame begins at time t₂₁, as shown in FIG. 4. Similar to the discharge phase in the first image frame (at time t₁₁), the discharge phase in the second image frame at time t₂₁ begins with the voltage on the actuation voltage interconnect 316 being pulled down to 0 V and the voltage on the shutter-close actuator 324 being raised to V_{act} as shown in FIG. 5D. These voltage transitions are shown in the actuation voltage waveform 402 and the shutter-close actuator voltage waveform 408 at time t₂₁. But unlike the time period prior to the discharge phase at time t₁₁, during which the voltage at Node B and at Node A are 0 V, the time period prior to the discharge phase at time t₂₁ has the voltages at Node B and at Node A at about V_{act} and V_{fb}, respectively. As a result, the charge-discharge transistor 306 remains in an ON state. Thus, when the actuation voltage interconnect 316 is pulled down to 0 V, Node B is discharged via the charge-discharge transistor 306, such that the voltage at Node B is reduced to about 0 V (as shown in FIG. 4, waveform 412 and FIG. 5D). This, in turn, causes the voltage on the shutter 320 to fall to about 0 V as well. However, because the voltage on the shutter-close actuator 324 is raised to V_{act} at about the same time, the shutter 320 remains attracted to the shutter-close actuator 324. Thus, the state of the light modulator 302 remains in the CLOSED state of the previous image frame.

In some implementations, maintaining the state of the light modulator 302 while loading data for the next image frame can allow the display to increase the time for which a backlight or a light source can be illuminated. For example, as discussed above, by changing the voltage on the shutter-close actuator 324 from 0 V to V_{act}, the shutter 320 can be maintained in the state from the preceding image frame. Increasing the time period for which the backlight or the light source can be illuminated can allow improvements in the power consumption or in the image quality of the display or in both power consumption and image quality of the display.

The data associated with the second image frame is the same as the data associated with the previous first image frame. Thus, at the start of the data load phase at time t₂₂, the voltage on the data interconnect 312 is at V_{d}, as shown in the data voltage waveform 404 and in FIG. 5E. At time t₂₂, when the row enable voltage on the row interconnect 314 is raised to Vₑₙ, Node A is charged substantially to V_{d}, as shown in the Node A voltage waveform 410 in FIG. 4. As Node B is maintained at about 0 V, the data capacitor 310 is charged to the data voltage V_{d}. Thus, the charge-discharge transistor 306 remains in the ON state.

Similar to the beginning of the actuation phase for the first image frame at time t₁₃, the actuation phase for the second image fame, at time t₂₃, begins with the voltage on the actuation voltage interconnect 316 being raised to V_{act}, as shown in the actuation voltage waveform 402 in FIG. 4. As the charge-discharge transistor 306 is in the ON state (as shown in FIG. 5F), the voltage on the Node B also begins to increase. Similar to the operation discussed above in relation to the first image frame after time t₁₃, the increase in the voltage of Node B will result in the increase in the voltage on Node A. In addition, the feedback transistor 308 switches ON causing Node A to be charged from the feedback voltage interconnect 318. This allows the voltage on Node B to increase to V_{act}.

Also at time t₂₃, the voltage on the shutter-close actuator 324 is decreased to about 0 V, as shown in the shutter-close actuator voltage waveform 408 in FIG. 4. As the shutter 320 is maintained at V_{act}, the shutter 320 is attracted to the shutter-close actuator 324, resulting in the light modulator 302 being maintained in the CLOSED state (as shown in FIG. 5F and in the shutter position waveform 414 in FIG. 4).

The discharge phase for the third image frame begins at time t₃₁. Similar to the discharge phases for the first and the second image frames starting at times t₁₁ and t₂₁, the discharge phase for the third time period begins with the voltage on the actuation voltage interconnect 316 transitioning from V_{act} to about 0 V, and the voltage on the shutter-close actuator 324 transitioning from about 0 V to about V_{act}. As shown in FIG. 5G, Node B discharges to about 0 V through the charge-discharge transistor 306. As a result, the voltage on the shutter 320 is about 0 V. However, as the voltage on the shutter-close actuator 324 is changed to V_{act}, the shutter 320 is maintained in the CLOSED position. Further, the decrease in the voltage at Node B causes the feedback transistor 308 to switch OFF.

The data load phase for the third image frame begins at time t₃₂. Unlike the data load phases of the first and the second image frames, where the voltage on the data interconnect is about V_{d}, in the data load phase for the third image frame the voltage on the data interconnect is instead about 0 V (as shown in the data voltage waveform 404 in FIG. 4). Therefore, when the voltage on the row interconnect 314 increases to Vₑₙ, switching the data transistor 304 ON, the voltage on Node A is reduced to about 0 V (as shown in the Node A voltage waveform 410 and in FIG. 5H). As shown in FIG. 5H, the gate terminals of both the charge-discharge transistor 306 and the feedback transistor 308 are at 0 V. Thus, both the charge-discharge transistor 306 and the feedback transistor 308 are switched OFF.

The actuation phase for the third image frame begins at time t₃₃. The voltage on the actuation voltage interconnect 316 is raised to V_{act}. As shown in FIG. 5I, the charge-discharge transistor 306 is switched OFF. Therefore, the decrease in the voltage on the actuation voltage interconnect 316 does not change the voltage at Node B or the shutter 320.

Also at time t₃₃, the voltage on the shutter-close actuator 324 is reduced to about 0 V, as shown in the shutter-close actuator voltage waveform 408 and in FIG. 5I. As the voltage on the shutter 320 is 0 V, and the voltage on the shutter-open actuator 322 is V_{act}, the shutter 320 is attracted to the shutter-open actuator 322. As a result, the shutter 320 switches from a CLOSED position to an OPEN position.

In some implementations, the voltages provided to the shutter-open actuator 322 and the shutter-close actuator 324 can be swapped. For example, the shutter-close actuator 324 can be maintained at a constant voltage of V_{act}, while the shutter-close actuator voltage waveform 408 shown in FIG. 4 can instead be applied to the shutter-open actuator 322. In some implementations, the voltages can be swapped periodically or occasionally (say, for example, every few image frames). In some implementations, repeatedly swapping the voltages provided to the shutter-open actuator 322 and the shutter-close actuator 324 can reduce charge build-up on the actuators. Reducing charge build-up can reduce the risk of incorrect operation of the light modulator 302.

As discussed above, various nodes within the pixel circuit 300 are charged during an actuation phase by increasing the voltage on the actuation voltage interconnect 316, for example, at times t₁₃ and t₂₃. Subsequently, during the discharge phase, the charge stored in the pixel circuit 300 is discharged by decreasing the voltage on the same actuation voltage interconnect 316, for example, at times t₂₁ and t₃₁. As the actuation voltage on the actuation voltage interconnect 316 is provided by the same actuation voltage source, a portion of the charge provided by the actuation voltage source during an actuation phase is recovered during the discharge phase. This charge recovery allows recovery of charge that would otherwise be discharged to ground in other pixel circuits and would add to the power losses of the display, thereby reducing power consumption.

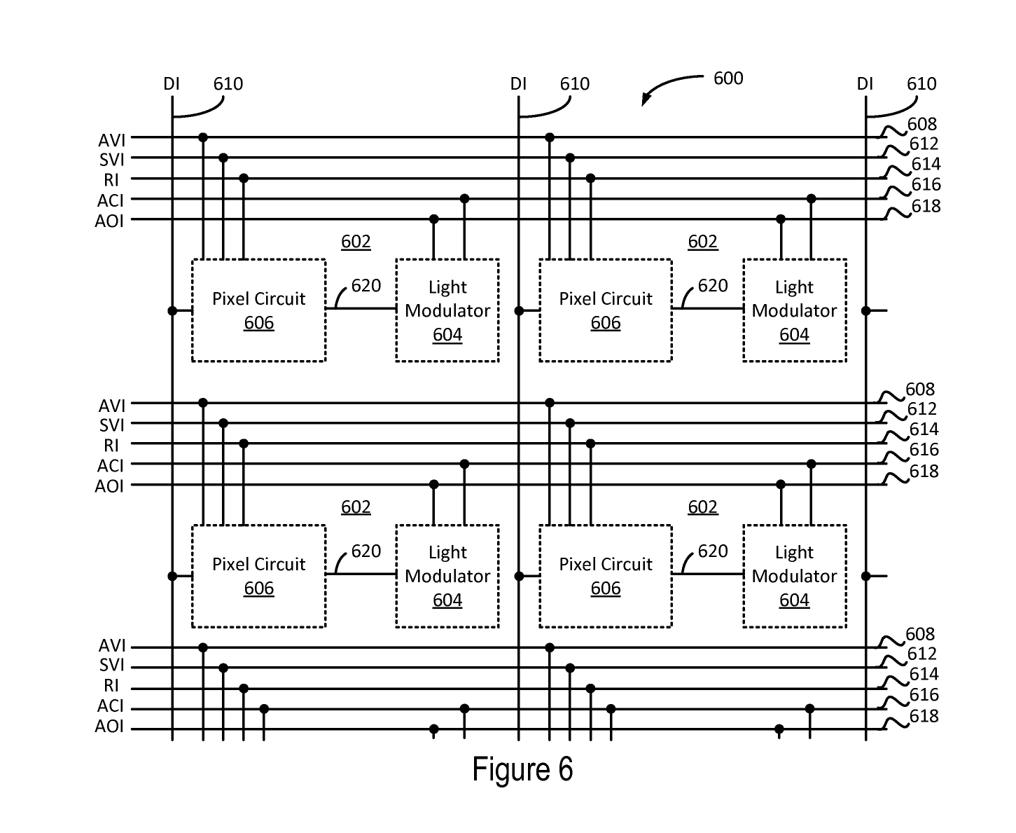

FIG. 6 shows a schematic diagram of an example control matrix 600. The control matrix 600 is suitable for controlling the light modulators incorporated into the MEMS-based display apparatus 100 of FIG. 1A. The control matrix 600 may address an array of pixels 602. Each pixel 602 can include a light modulator 604, such as the dual actuator shutter assembly 200 of FIGS. 2A and 2B or the light modulator 302 shown in FIG. 3. Each pixel 602 also can include a pixel circuit 606, such as the pixel circuit 300 shown in FIG. 3. While FIG. 6 shows the control matrix 600 having two rows and two columns of pixel 602, it is understood that the control matrix 600 can include additional rows and columns of pixels 602.

The control matrix 600 includes an actuation voltage interconnect (AVI) 608, a data interconnect (DI) 610, a feedback voltage interconnect (SVI) 612, a row interconnect (RI) 614, a shutter-close global interconnect (ACI) 616, and a shutter-open global interconnect (AOI) 618. In some implementations, the actuation voltage interconnect 316, the data interconnect 312, the feedback voltage interconnect 318, and the row interconnect 314, shown in FIG. 3 are examples of the actuation voltage interconnect 608, the data interconnect 610, the feedback voltage interconnect 612, and the row interconnect 614, respectively. As such, the actuation voltage interconnect 608 can provide an actuation voltage (such as about 0 V to about V_{act}), the data interconnect 610 can provide the data voltage (such as about 0 V to about V_{d}), the feedback voltage interconnect can provide a feedback voltage (V_{fb}), and the row interconnect 614 can provide the row enable voltage (such as about 0 V to about Vₑₙ) for the operation of the pixel circuit 606. The shutter-close actuator interconnect 616 can provide voltage to the shutter-close actuators (such as the shutter-close actuator 324 shown in FIG. 3) of each of (or a subset of) the light modulators 604 in the control matrix 600. Similarly, the shutter-open actuator interconnect 618 can provide voltage to the shutter-open actuators (such as the shutter-open actuator 322 shown in FIG. 3) of each of (or a subset of) the light modulators 604 in the control matrix 600. In some implementations, the actuation voltage, the feedback voltage, and the voltages to the shutter-open and shutter-close actuators 322 and 324 can be provided by the voltage sources and drivers 160 shown in FIG. 1B. Further, the row enable voltage and the data voltage can be provided by the scan drivers 130 and the data drivers 132 also shown in FIG. 1B.

Each pixel circuit 606 can include an interconnect 620 that connects an output node of the pixel circuit 606 to the light modulator 604. In some implementations, the interconnect connecting Node B to the shutter 320 of the light modulator 302 shown in FIG. 3 can be an example of the interconnect 620. While not shown in FIG. 6, the control matrix 600 can include a controller, such as the controller 134 shown in FIG. 1B for controlling the timing and the magnitude of the signals provided to each of the interconnects of the control matrix 600.

In operation, to form an image, the control matrix 600 can perform discharge phase for all the pixels 602, followed by a row-by-row data-load phase for each row of pixels 602 in the control matrix 600, and an actuation phase for actuating all the pixels 602. Examples of the discharge phase, the data-load phase, and the actuation phase have been discussed above in relation to FIGS. 4-5I.

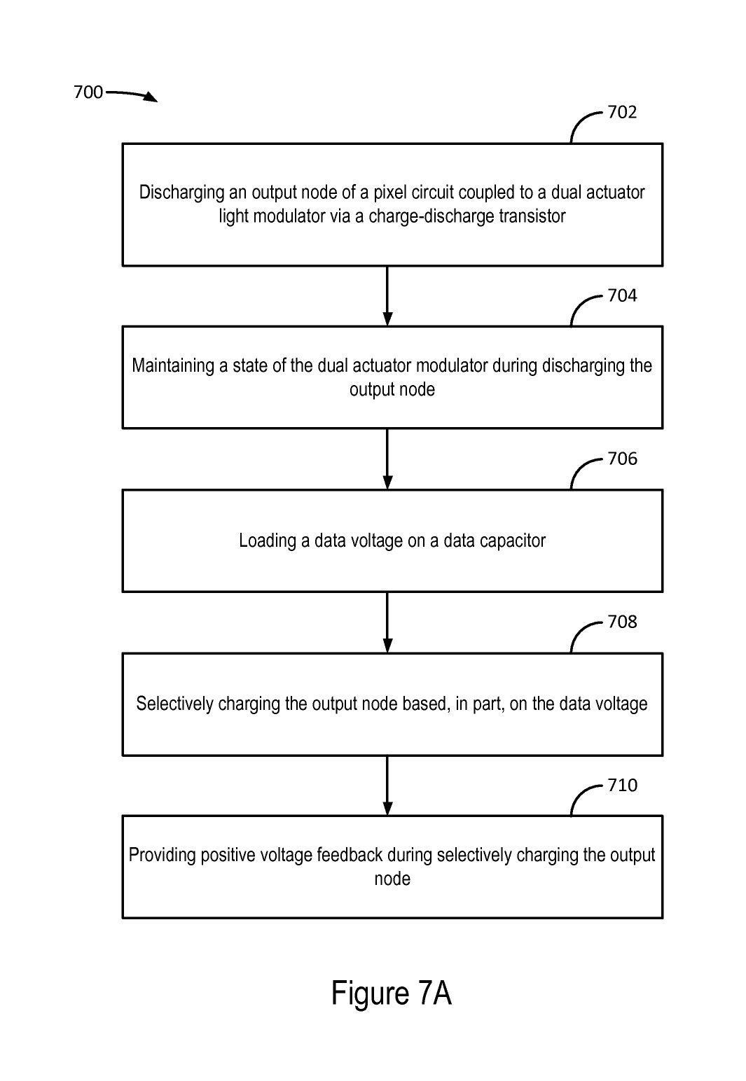

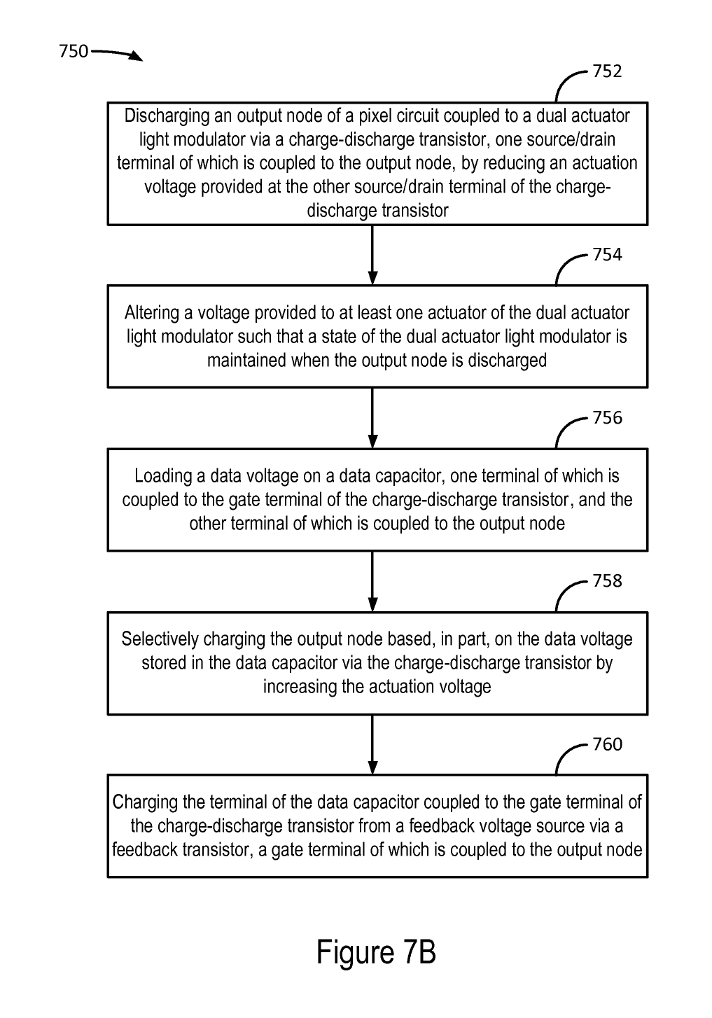

FIG. 7A shows an example flow diagram of a process 700 for operating a dual-actuator light modulator using a pixel circuit, such as the pixel circuit 300 shown in FIG. 3. In particular, the process 700 can be used by the control matrix 600 for controlling the operation of the light modulators 604. The process 700 includes discharging an output node of a pixel circuit coupled to a dual actuator light modulator via a charge-discharge transistor (stage 702), maintaining a state of the dual actuator light modulator during discharging the output node (stage 704), loading a data voltage on a data capacitor (stage 706), selectively charging the output node based, in part, on the data voltage (stage 708), and providing positive feedback during selectively charging the output node (stage 710).

The process 700 includes discharging an output node of a pixel circuit coupled to a dual actuator light modulator via a charge-discharge transistor (stage 702). One example of this process stage has been discussed above in relation to FIG. 5D. Specifically, FIG. 4 shows discharging Node B, which is coupled to the light modulator 302, via the charge-discharge transistor 306 when the voltage on the actuation voltage interconnect 316 is reduced to 0 V. The process 700 also includes maintaining a state of the dual actuator light modulator during discharging the output node (stage 704). One example of this process stage has been discussed above in relation to FIG. 5D where the CLOSED state of the light modulator 302 is maintained during the discharge of Node B. The process 700 further includes loading a data voltage on a data capacitor (stage 706). One example of this process stage has been discussed above in relation to FIG. 5E where the data voltage on the data interconnect 312 is stored in the data capacitor 310. The process also includes selectively charging the output node based, in part, on the data voltage (stage 708). One example of this process stage has been discussed above in relation to FIG. 5F where Node B is charged, in part, because of the data voltage V_{d} stored in the data capacitor 310. The process 700 additionally includes providing positive feedback during selectively charging the output node (stage 710). One example of this process stage has been discussed above in relation to FIG. 5F where a feedback transistor 308 provides positive feedback voltage during the charging of Node B.

FIG. 7B shows another example flow diagram of a process 750 for operating a dual-actuator light modulator using a pixel circuit, such as the pixel circuit 300 shown in FIG. 3. The process 750 shown in FIG. 7B is similar to the process 700 shown in FIG. 7A, but includes additional details for each of process stages. The process 750 also can be used by the control matrix 600 for controlling the operation of the light modulators 604. The process 750 includes discharging an output node of a pixel circuit coupled to a dual-actuator light modulator via a charge-discharge transistor, one source/drain terminal of which is coupled to the output node, by reducing an actuation voltage provided at the other source/drain terminal of the charge-discharge transistor (stage 752), altering a voltage provided to at least one actuator of the dual actuator light modulator such that a state of the dual actuator light modulator is maintained when the output node is discharged (stage 754), loading a data voltage on a data capacitor, one terminal of which is coupled to the gate terminal of the charge-discharge transistor, and the other terminal of which is coupled to the output node (stage 756), selectively charging the output node, based in part on the data voltage stored in the data capacitor, via the charge-discharge transistor by increasing the actuation voltage (stage 758), and charging the terminal of the data capacitor coupled to the gate terminal of the charge-discharge transistor from a feedback voltage source via a feedback transistor, a gate terminal of which is coupled to the output node (stage 760).

The process 750 includes discharging an output node of a pixel circuit coupled to a dual actuator light modulator via a charge-discharge transistor, one source/drain terminal of which is coupled to the output node, by reducing an actuation voltage provided at the other source/drain terminal of the charge-discharge transistor (stage 752). One example of this process stage has been discussed above in relation to FIG. 5D. Specifically, FIG. 5D shows discharging Node B via the charge-discharge transistor 306 when the voltage on the actuation voltage interconnect 316 is reduced to 0 V. Another example of this process stage has been discussed above in relation to FIG. 5A, where Node B is discharged to 0 V via the charge-discharge transistor 306 when the actuation voltage interconnect 316 is reduced to 0 V during a previous image frame.

The process 750 further includes altering a voltage provided to at least one actuator of the dual actuator light modulator such that a state of the dual actuator light modulator is maintained when the output node is discharged (stage 754). One example of this process stage is discussed above in relation to FIG. 5D. Specifically, in the discharge phase, the voltage provided to the shutter-close actuator 324 is increased from 0 V to V_{act} when the shutter 320 is discharged. As a result, the shutter 320 remains attracted to the shutter-close actuator 324, thereby maintaining the CLOSED state of the light modulator 302.

The process 750 also includes loading a data voltage on a data capacitor, one terminal of which is coupled to the gate terminal of the charge-discharge transistor, and the other terminal of which is coupled to the output node (stage 756). One example of this process stage has been discussed above in relation to FIG. 5E. Specifically, in the data-load phase, the data voltage V_{d} provided by the data interconnect 312 is loaded onto the data capacitor 310, which is coupled between the gate and the source/drain terminals of the charge-discharge transistor 306.

The process 750 further includes selectively charging the output node, based in part on the data voltage stored in the data capacitor, via the charge-discharge transistor by increasing the actuation voltage (stage 758). One example of this process stage has been discussed above in relation to FIG. 5F. Specifically, in the actuation phase, charge-discharge transistor 306 is in the ON state due to the data voltage V_{d} stored in the data capacitor 310. As the voltage on the actuation voltage interconnect 316 increases, Node B is charged via the charge-discharge transistor 306. Another example of this process stage has been discussed above in relation to FIG. 5I, where in the actuation phase Node B is not charged as the charge-discharge transistor 306 is in the OFF state due to the data voltage of about 0 V stored in the data capacitor 310.

The process 750 also includes charging the terminal of the data capacitor coupled to the gate terminal of the charge-discharge transistor from a feedback voltage source via a feedback transistor, a gate terminal of which is coupled to the output node (stage 760). One example of this process stage has been discussed above in relation to FIG. 5F. Specifically, when the voltage on Node B increases, the feedback transistor 308 is switched ON, causing the voltage on Node A, which is coupled to the gate terminal of the charge-discharge transistor 306, to increase. The increase in the voltage on Node A ensures that the data voltage V_{d} is maintained across the data capacitor, and that Node B can be charged to the actuation voltage.

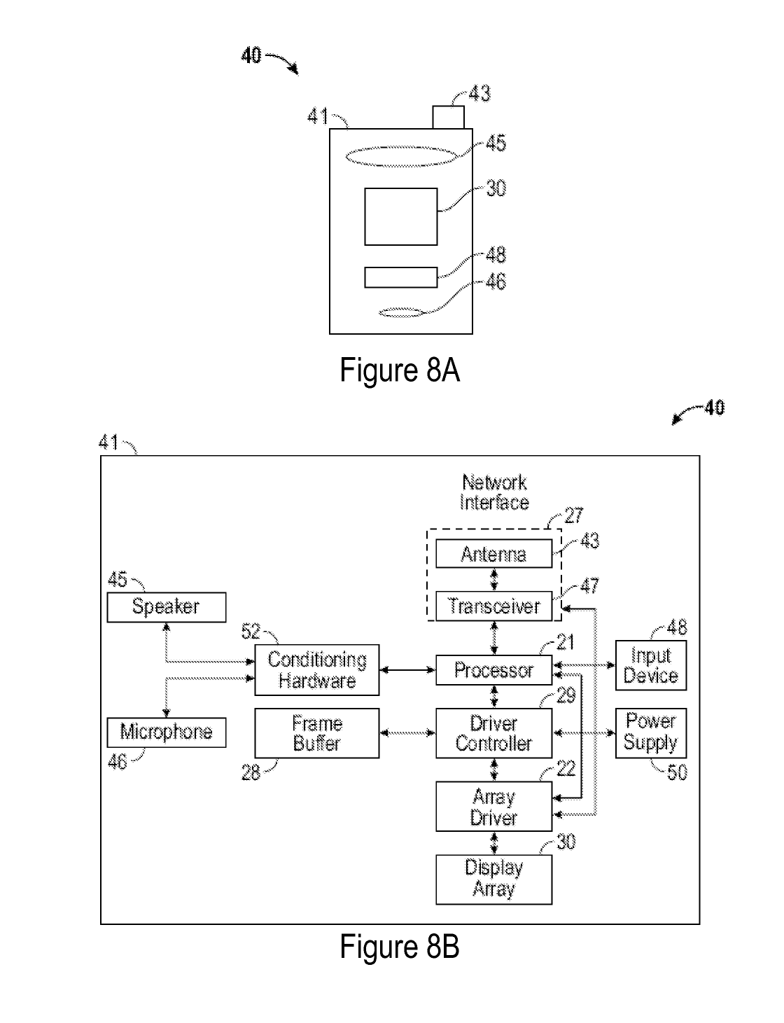

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware, software, or both hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a light modulator capable of selectively allowing passage of light;
a pixel circuit having an output node coupled to the light modulator, including:
a charge-discharge transistor configured to selectively charge and selectively discharge the output node coupled to one of its source/drain terminals through application and removal of an actuation voltage provided by an actuation voltage source at the other one of its source/drain terminals;
a data storage capacitor having a first terminal coupled to the gate terminal of the charge-discharge transistor and a second terminal coupled to the output node configured to store a data voltage representative of image data; and
a feedback transistor configured to selectively provide charge to the gate terminal of the charge-discharge transistor and to the data storage capacitor coupled to its drain terminal from a feedback voltage provided at its source terminal.

2. The display apparatus of claim 1, wherein the gate terminal of the feedback transistor is coupled to the output node, and wherein the feedback transistor is configured to provide charge to the data storage capacitor when the output node is charged by the charge-discharge transistor.

3. The display apparatus of claim 1, wherein the output node is coupled to a shutter terminal of the light modulator.

4. The display apparatus of claim 3, wherein the light modulator is provided with an actuation voltage on one of its two actuators such that a state of the light modulator is maintained when the output node is discharged by the charge-discharge transistor.

5. The display apparatus of claim 4, wherein the other of the two actuators of the light modulator is maintained at a constant voltage.

6. The display apparatus of claim 1, wherein the output node is coupled to an actuator of the light modulator.

7. The display apparatus of claim 1, further comprising an input transistor, one of the source/drain terminals of which is coupled to the first terminal of the storage capacitor, the other of the source/drain terminal of which is coupled to a data interconnect, and a gate terminal of which is coupled to a row enabling interconnect.

8. The display apparatus of claim 1, wherein each of the charge-discharge transistor and the feedback transistor is an n-type transistor.

9. The display apparatus of claim 1, further comprising:
a display including:
the light modulators, and the pixel circuit,
a processor that is capable of communicating with the display, the processor being capable of processing image data; and
a memory device that is capable of communicating with the processor.

10. The display apparatus of claim 9, the display further including:
a driver circuit capable of sending at least one signal to the display; and
a controller capable of sending at least a portion of the image data to the driver circuit.

11. The display apparatus of claim 9, further including:
an image source module capable of sending the image data to the processor, wherein the image source module comprises at least one of a receiver, transceiver, and transmitter.

12. The display apparatus of claim 9, the display further including:
an input device capable of receiving input data and to communicate the input data to the processor.

13. A method for actuating a dual actuator light modulator using a pixel circuit having an output node coupled to the light modulator, comprising:
discharging the output node via a charge-discharge transistor, one source/drain terminal of which is coupled to the output node, by reducing an actuation voltage provided at the other source/drain terminal of the charge-discharge transistor;
altering a voltage provided to at least one actuator of the dual actuator light modulator such that a state of the dual actuator light modulator is maintained when the output node is discharged;
loading a data voltage on a data capacitor, one terminal of which is coupled to the gate terminal of the charge-discharge transistor, and the other terminal of which is coupled to the output node;
selectively charging the output node, based in part on the data voltage stored in the data capacitor, via the charge-discharge transistor by increasing the actuation voltage; and
charging the terminal of the data capacitor coupled to the gate terminal of the charge-discharge transistor from a feedback voltage source via a feedback transistor, a gate terminal of which is coupled to the output node.

14. The method of claim 13, further comprising restoring the voltage provided to the at least one actuator of the dual actuator light modulator after increasing the actuation voltage.

15. The method of claim 13, wherein altering a voltage provided to at least one actuator of the dual actuator light modulator such that a state of the dual actuator light modulator is maintained when the output node is discharged includes altering the voltage provided to the at least one actuator substantially simultaneously with reducing the actuation voltage.

16. The method of claim 13, wherein charging the terminal of the data capacitor coupled to the gate terminal of the charge-discharge transistor from a feedback voltage source via a feedback transistor, a gate terminal of which is coupled to the output node includes charging the terminal of the data capacitor such that the data voltage stored in the data capacitor is maintained.

17. A display apparatus, comprising:
light modulating means for selectively allowing passage of light;
charge-discharge means for selectively charging and selectively discharging an output node coupled to the light modulating means through an actuation voltage source;
data storage means coupled to the charge-discharge means for storing a data voltage representative of image data; and
feedback means for selectively providing charge to the data storage means from a feedback voltage source.

18. The display apparatus of claim 17, wherein the feedback means provide charge to the data storage means from a feedback voltage source when the output node is charged by the charge-discharge means.

19. The display apparatus of claim 17, wherein the light modulating means include a shutter and at least two actuators, wherein the output node is coupled to the shutter.

20. The display apparatus of claim 17, wherein the light modulating means is provided with an actuation voltage on one of its at least two actuators such that a state of the light modulating means is maintained when the output node is discharged by the charge-discharge means.
